(19) United States
(12) Patent Application Publication
(10) Pub. No.: US 2011/0205048 A1
(43) Pub. Date: Aug. 25, 2011

(54) COMPUTER SOFTWARE AND APPARATUS FOR CONTROL AND MONITORING OF ELECTRONIC SYSTEMS

(75) Inventor: Troy Dane Lentz, Lee's Summit, MO (US)

(73) Assignee: EV Instruments, LLC, North Kansas City, MO (US)

(21) Appl. No.: 13/032,249

(22) Filed: Feb. 22, 2011

Related U.S. Application Data
(60) Provisional application No. 61/306,856, filed on Feb. 22, 2010.

(51) Int. Cl. G09F 9/00

(52) U.S. Cl. 340/461

(57) ABSTRACT

A system for interfacing with a vehicle broadly comprises a processing element, a memory element, a display, a user interface, a network port, a device port, and a vehicle interface unit. The processing element executes computer code or programs and is in communication with the memory element, which stores programs and data. The display presents information to a user. The user interface allows the user to interact with and enter information into the system. The network port allows the system to communicate with other systems or devices. The device port provides communication with a plurality of external components. The vehicle interface unit is coupled with the vehicle components and a plurality of batteries and is configured to determine a voltage level and a charge level of each of the batteries. The vehicle interface unit is alternatively coupled with the vehicle components and components of an engine to determine performance parameters.

### RELATED APPLICATION

The present non-provisional application claims priority benefit, with regard to all common subject matter, to U.S. Provisional Patent Application No. 61/306,856, entitled “COMPUTER SOFTWARE AND APPARATUS FOR CONTROL AND MONITORING OF ELECTRONIC SYSTEMS,” filed Feb. 22, 2010, which is hereby incorporated by reference in its entirety into the present application.

### BACKGROUND

1. Field

Embodiments of the present invention relate to systems and methods for interfacing with an electric or high-performance vehicle.

2. Summary

Display and control systems that interface with vehicles are generally provided by the manufacturer of the vehicle. The systems are typically designed to prohibit a user from installing additional components or from reprogramming the control processor. With electric vehicles, the systems also may present limited information on a battery or battery collection to the user. With high-performance vehicles, the systems may present limited information on the parameters of an engine.

Embodiments of the invention provide a system and methods for interfacing with a vehicle. The user may add components to the system and configure the system to interact with the components, thus making the system customizable for the particular user's preferences. For example, the user may configure the system to display information about the components and to provide controls for controlling the operation of the components. In addition, the system may monitor and display information about the performance of each battery that is utilized in an electric vehicle or the parameters of an engine in a high-performance vehicle.

One embodiment of the present invention provides a system for interfacing with an electric vehicle that broadly comprises a display, a vehicle interface unit, and a processing element. The vehicle interface unit may be coupled to a plurality of batteries for powering the electric vehicle and configured to determine a voltage level and a charge level of each battery. The processing element may be in communication with a memory element and programmed to record the voltage level and the charge level of each battery at a regular time interval, store the voltage level and the charge level of each battery in the memory element, and send the voltage level and the charge level to the display to be displayed in a numeric format.

Another embodiment provides a computer-readable storage medium with an executable program stored thereon for interfacing with an electric vehicle. The program instructs a processing element to receive a voltage level and a charge level from a vehicle interface unit to which a plurality of batteries are connected, record the voltage level and the charge level of each battery at a regular time interval, and display the voltage level and the charge level of each battery in a numeric format.

Another embodiment provides a system for interfacing with a high-performance vehicle that broadly comprises a display, a vehicle interface unit, and a processing element. The vehicle interface unit may be coupled to components of an internal combustion engine and configured to determine a plurality of performance parameters. The processing element may be in communication with a memory element and programmed to record each performance parameter at a regular time interval, store each performance parameter in the memory element, and send each performance parameter to the display to be displayed along with the alert for each performance parameter to indicate when the performance parameter exceeds a minimum or maximum boundary.

Another embodiment provides a computer-readable storage medium with an executable program stored thereon for interfacing with a high-performance vehicle. The program instructs a processing element to receive a plurality of performance parameters from a vehicle interface unit to which components of an internal combustion engine are connected, record a value of each performance parameter at a regular time interval, and display the value of each performance parameter and an alert for each performance parameter to indicate when the performance parameter exceeds a minimum or maximum boundary.

Another embodiment provides a method for configuring a system including a processing element coupled with a memory element that interfaces with an electric vehicle. The method comprises the steps of entering computer code into the system to receive a plurality of voltage levels and charge levels from a vehicle interface unit to which a plurality of batteries are connected, entering computer code into the system to record the voltage level and charge level of each battery at a regular time interval, and entering computer code into the system to display the voltage level and charge level of each battery in a numeric format.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic block diagram of a system, constructed in accordance with various embodiments of the present invention, for interfacing with an electric vehicle;

FIG. 2 is a perspective view of an embodiment of the system, including a display, a first housing, a second housing, and a first case.

FIG. 3 is a flow diagram of at least a portion of the steps of a method of interfacing with an electric vehicle; and

FIG. 4 is a flow diagram of at least a portion of the steps of a method of configuring a system that interfaces with an electric vehicle.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

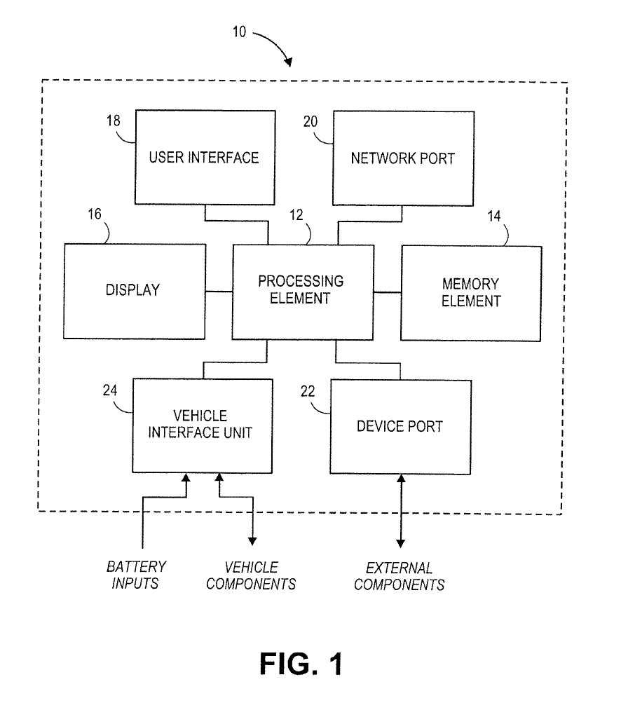

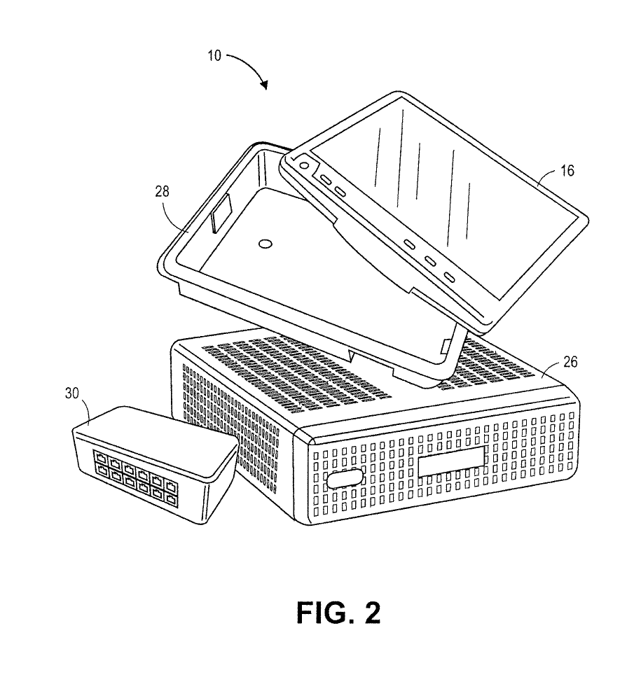

A system 10, constructed in accordance with various embodiments of the present invention, for interfacing with an electric or high-performance vehicle is shown in FIG. 1. The vehicle may be all-electric, a plug-in hybrid, a traditional hybrid, a sports utility vehicle, a luxury vehicle, a custom or modified vehicle, a racing vehicle, or other high-performance automobiles or trucks. The system 10 may broadly comprise a processing element 12, a memory element 14, a display 16, a user interface 18, a network port 20, a device port 22, and a vehicle interface unit 24. Various embodiments of the system 10 may further include a first housing 26, a second housing 28, and a first case 30, as seen in FIG. 2.

The processing element 12 generally executes computer code, programs, or applications and may include devices such as processors, microprocessors, microcontrollers, field programmable gate arrays (FPGAs), combinations thereof, and the like. The processing element 12 may further include clocks or timers. An exemplary processing element 12 may include an Atom-class or Pentium-class microprocessor or central processing unit (CPU) operating at 2.8 gigahertz (GHz) or higher.

The processing element 12 may utilize a computer operating system, such as Windows® from Microsoft®, Inc. of Redmond, Wash. or Linux open source operating system. The processing element 12 may be programmed using programming languages such as C#, .NET, and Flash programming. This allows the user to customize the performance of the system 10 based on the needs of the vehicle with which the system 10 is interfacing or based on user preferences.

The memory element 14 generally stores data to be utilized by the system 10. The data may include computer code, programs, applications, system settings, user preferences, measured data, combinations thereof, and the like. The memory element 14 may be configured to communicate with the processing element 12. The memory element 14 may include a “computer-readable medium” which may be any device that can contain, or store the computer code, programs, or applications for use by or in connection with the processing element 12. Examples of the computer-readable medium may include random-access memory (RAM) such as static RAM (SRAM) or dynamic RAM (DRAM), cache memory, read-only memory (ROM), flash memory, hard-disk drives, compact disc ROM (CDROM), digital video disc (DVD), or Blu-Ray™ combinations thereof, and the like. An exemplary memory element 14 may include 2 gigabytes (GB) of RAM and a 16-GB hard disk drive.

The display 16 generally presents visual information, such as graphics, text, or combinations thereof, to a user. The display 16 may be configured to communicate with the processing element 12. The display 16 may include any monitor or video device that utilizes technologies such as cathode ray tube (CRT), plasma, liquid crystal display (LCD), light-emitting diode (LED), LED-LCD, combinations thereof, and the like. The display 16 may present any screen shape and aspect ratio. In various embodiments, the display 16 may also include touchscreen capability, such that the user may touch the screen to enter data, respond to prompts, display menus or additional screens, and the like. An exemplary display 16 may include a 7-inch, 8-inch, or 10-inch flat, widescreen LCD monitor with touchscreen capability.

The user interface 18 generally allows the user to enter data into the system 10. The user interface 18 may be configured to communicate with the processing element 12 and may include devices such as keyboards, keypads, mice, tablets, pushbuttons, switches, knobs, dials, combinations thereof, and the like. In some embodiments, the system 10 may rely only on the display 16 with touchscreen capability for user input. In other embodiments, the system 10 may include the user interface 18 in addition to, or instead of, the display 16 with touchscreen capability.

The network port 20 generally allows the system 10 to transmit and receive data from external sources. The network port 20 may be configured to communicate with the processing element 12. The network port 20 may also couple to a network, such as the Internet, and may be able to communicate electronically, through wires or cables, optically, through optical fibers, wirelessly, using radio frequency (RF) protocols, such as IEEE 802.11 standards, combinations thereof, and the like. The system 10 may utilize the network port 20 to download computer programs or applications to be executed by the processing element 12, as well as to upload data that is stored in the memory element 14.

The device port 22 generally provides communication between the processing element 12 and a plurality of external components. The device port 22 may include parallel ports, serial ports, USB ports, IEEE 1394 high-speed serial bus ports, combinations thereof, and the like. The device port 22 may connect to the external components through a wire or cable, optical fiber, or wirelessly. An exemplary device port 22 may include a plurality of USB ports.

The device port 22 may couple to external components including music players, such as radio, high-definition radio, satellite radio, CD players, MP3 players, and the like, video players, such as DVD players, Blu-Ray™ players, and the like, global positioning system (GPS) navigators, mobile phones, and other entertainment, navigation, or communications devices. The external components may include components that the user has added to customize the electric vehicle factory-installed components, or combinations thereof. Through the device port 22, the processing element 12 may receive input from the external components and may send information regarding the components to the display 16 to be shown to the user. For example, the display 16 may show the name and artist for a song playing on the music player, the name of a movie or show playing on the video player, the current heading or distance to a destination from the GPS navigator, the name of a caller on the mobile phone, or other information appropriate for each external component.

The processing element 12 may also transmit signals through the device port 22 to the external components in order to control the functions of the components or turn the components on or off. The processing element 12 may transmit signals to the external components either automatically at a given time or when a certain condition is met, or when initiated by the user through the user interface 18. For example, the processing element 12 may select a new station, song, or playlist on the music player, a different scene or movie on the video player, a different destination on the GPS navigator, or initiate a phone call on the mobile phone.

The vehicle interface unit 24 generally provides communication between the processing element 12 and the vehicle. The vehicle interface unit 24 may include electronic components such as discrete components, relays, amplifiers, transformers, analog-to-digital converters (ADCs), digital-to-analog converters (DACs), signal processors, circuitry that adjusts the levels of voltage or current, circuitry that converts current to voltage, circuitry that converts voltage to current, connectors, combinations thereof, and the like. The vehicle interface unit 24 may be implemented on a printed circuit board and may communicate with the processing element 12 electronically, optically, or wirelessly. An exemplary vehicle interface unit 24 may communicate with the processing element 12 through a cable connected to a universal serial bus (USB) port that is in communication with the processing element 12.

The vehicle interface unit 24 may communicate with one or more batteries from the vehicle and receives or determines the voltage level and/or the charge in terms of amp-hours from each battery. In addition, the information from each battery received by the vehicle interface unit 24 may be stored in the memory element 14 at regular time intervals. The vehicle interface unit 24 generally receives input from the batteries via a wire or cable, but may also receive input wirelessly. The vehicle interface unit 24 may receive input from different types of batteries, such as lithium, lead-acid, or absorbed glass mat (AGM), or different levels of voltage, such as 3-Volt, 6-Volt, or 12-Volt. An exemplary vehicle interface unit 24 may receive inputs from up to forty-eight batteries.

The vehicle interface unit 24 may also communicate with the components of an internal combustion engine. The components may include an on-board diagnostics unit, a tachometer, a speedometer, or other meters and sensors. The vehicle interface unit 24 may receive or determine vehicle speed, engine turnover in revolutions per minute (RPMs), engine temperature, horsepower, torque, acceleration, fuel level, fuel consumption, fuel mixture, oil pressure, fuel pressure, oil temperature, exhaust temperature, air intake, engine vacuum, boost or turbocharger pressure, combinations thereof, and the like. As it does when interfacing with a battery system, the processing element 12 may direct the memory element 14 to record the information received or determined by the vehicle interface unit 24 with regard to the parameters of the engine.

The vehicle interface unit 24 may further communicate with other components of the vehicle such as headlights, a temperature control system, windshield wipers, an odometer, a speed sensor, a tire pressure sensor, motor, cabin, or external thermometers, rain detectors, external darkness detectors, and the like. The processing element 12 may receive input from the vehicle components and may send information regarding the components to the display 16 to be shown to the user. For example, the display 16 may show whether the headlights are on, the settings of the temperature control system, tire pressure, internal or external temperature, or other information appropriate for the vehicle components. The vehicle interface unit 24 may connect to the components of the vehicle through wires or cables. In some embodiments, the vehicle interface unit 24 may connect to vehicle components through optical fiber, or wirelessly.

The processing element 12 may also transmit signals through the vehicle interface unit 24 to the vehicle components in order to control the functions of the components or turn the components on or off. The processing element 12 may transmit signals to the vehicle components either automatically at a given time or when a certain condition is met, or when initiated by the user through the user interface 18. For example, the processing element 12 may turn the headlights on, adjust the settings of the temperature control system, turn the windshield wipers on, or the like, through instructions provided by the user via the user interface 18.

The first housing 26 generally houses the processing element 12, the memory element 14, the network port 20, and the device port 22. An exemplary first housing 26 may include a computer case with a mini-ATX form factor, as known in the art. The second housing 28 generally provides a mounting device for the display 16 when the display 16 is mounted in the dashboard of a vehicle. The first case 30 generally houses the vehicle interface unit 24 and may include one or more panels that are capable of receiving the connections from all the batteries and vehicle components.

Before the system 10 is installed in a vehicle, the user may configure the system 10. The user may assign which external components couple to the connections of the device port 22. The user may also assign which batteries and vehicle components couple to the connections of the vehicle interface unit 24. The user may create a text-based configuration initialization file, also known as a “.ini” file, that is stored in the memory element 14 and includes a listing of all of the external components, vehicle components, and batteries that are coupled to the system 10.

The system 10 may include a main menu screen which serves as the default screen that is automatically displayed when the system 10 is initialized. The main menu may include the list of all the external components, vehicle components, and batteries, which is derived from the configuration initialization file. Typically, the information for each component and the batteries is displayed on one, or more if necessary, screen of the display 16. The main menu may also include indicators for switching to the screen for each external component, vehicle component, or the batteries. The user may select the indicator for the appropriate component or the batteries using the user interface 18. The display 16 may then show the screen for the selected component or the batteries. Furthermore, each screen may include an indicator, such as “Back” or “Main Menu”, to return back to the main menu.

The user may download, using the network port 20, programs or applications, or enter computer code or user settings, using the user interface 18, that control what information is displayed for each external component and how it is displayed. The screen for each component may show the status of the component such as current settings or outputs, as well as input indicators for controlling the operation of the component. For example, a screen for a music player component may display settings such as the radio station name, the name of a CD, the name of a playlist, the artist and title of a song, as well as input indicators to skip to the next or last song, to change the radio station, to adjust the volume, and the like. In addition, the user may be able to control the appearance of the information and indicators. For example, the user may be able to control the color, the size, and the font of the information and indicators, as well as parameters such as where the information appears on the screen. In addition, the user may set up fields of information that can be selected or deselected when a screen is displayed during usage of the system 10. The fields may be selected to display more information or deselected to display less information.

The user may also download programs or applications or enter computer code or user settings that control what information is displayed for the batteries, the internal combustion engine, and the vehicle components. For example, a screen may show the status of all of the batteries in the vehicle including information such as the voltage levels, the amount of charge used, the amount of charge left in terms of amp-hours for the aggregate and/or each battery. The user may control the appearance including whether the information is shown as digital values, analog graphs, or both. The screen may also have an indicator for each battery, such that if the indicator is selected, then a screen is displayed that includes more detailed information on the selected battery. The detailed information may include a charge or discharge history over time for the battery, as well as statistical information such as the average value, the maximum value, the minimum value, and the like. The user may also enter computer code that allows the historical and statistical data to be uploaded from the system 10 to an external device through the network port 20.

One or more screens may show the status of the parameters of the engine. For example, a screen may display the engine turnover as a tachometer output, engine temperature, vacuum, oil pressure, oil temperature, fuel level, fuel pressure, horsepower, torque, acceleration, and the like. The engine parameter information may be displayed as analog gauges, digital readouts, or both. One or more screens may additionally display the maximum recorded RPM, a gear shift alert based on RPMs with user-programmable shift points, alerts for the engine parameters when the parameters exceed maximum or minimum boundaries, and the like.

Likewise, one or more screens may display information and inputs for the vehicle components such as the windshield wipers, the headlights, and the temperature control system. And, in the same fashion as above, the user may control the appearance of the information and inputs.

The user may further download or enter programs or drivers that control the communication between the processing element 12 and the external components or the vehicle components. The programs or drivers may include the proper command set for each component so that the processing element 12 may transmit the proper code to the component and be able to properly interpret the data received from the component. In some embodiments, there may be a driver for each component in use with the system 10. In other embodiments, groups of components may share a common driver.

In addition to screens that display information about individual components or the batteries, the user may also set up or create one or more screens that display information about the settings or status of groups of components. For example, the user may create a screen for displaying a plurality of gauges wherein each gauge shows a reading from a vehicle sensor, such as the vehicle speed, the mileage, the motor temperature, the cabin temperature, the external temperature, the tire pressure, and the like. Furthermore, the user may create a screen that displays a plurality of control indicators, such as switches, that control the function of various components. For example, the user may create a screen with indicators for controlling the cabin lights, the headlights, the windshield wipers, and the like.

After the system 10 is configured, it is generally installed into an electric or high-performance vehicle. The first housing 26 may be placed behind the dashboard or in another location where all of the external components can be easily connected to the device port 22. Likewise, the first case 30 may be positioned proximal to the first housing or in a location where all of the vehicle components and the batteries can be easily connected. The second housing 28, which holds the display 16, may be mounted in the dashboard so that the user can easily view and access the display 16.

The system 10 may operate as follows. When the system 10 is powered up, the processing element 12 may execute system self-diagnostics. If the self-diagnostics fail, then the display 16 may show a failure code or the name of a component that failed. If the self-diagnostics pass, then the processing element 12 may read the configuration initialization file, and the display 16 may show a list of all the external components, vehicle components, and batteries that are connected to the system 10.

The user may select, using the user interface 18, one of the components to monitor. The processing element 12 may open the configuration initialization file to retrieve any settings or options that are associated with the selected component, which are listed in the configuration initialization file. The display 16 may then show the screen associated with the selected component. The screen may include the status and/or settings of the component along with indicators for controlling the function of the component. The user may change a setting of the component by selecting a function-controlling indicator, such as changing the volume of the music player or selecting a different destination for the GPS navigator. The processing element 12 may then transmit the appropriate command to the component.

When the user wants to interact with a different component, he may select the indicator to return to the main menu. From the main menu, the user may select a different component to monitor or control. The processing element 12 may open the configuration initialization file and retrieve settings or options, as described above.

In addition, the user may select a screen that monitors a plurality of components on the same screen. For example, the user may select the screen that includes a plurality of gauges in order to monitor values such as the vehicle speed, the vehicle heading, the external temperature, the cabin temperature, and the like simultaneously. The user may also select the screen that includes a plurality of control indicators in order to control a plurality of components such as the headlights, the windshield wipers, the temperature control system, and the like simultaneously.

As an ongoing process, the system 10 may be monitoring components and recording data from the sensors. Thus, the system 10 may perform some operations automatically based on sensor data. For example, the processing element 12 may send a command to turn on the headlights when the external ambient light falls below a certain level, or turn on the windshield wipers if rain is detected on the windshield, or similar operations appropriate for each component. The processing element 12 may also send a warning message to the display 16 to warn the user if the tire pressure falls below a certain level, if the motor temperature rises above a certain level, or if other components drift outside their operating parameters.

The system 10 may also continuously monitor and record data from the batteries. The user may select the screen to display the status of the batteries. The screen may include the voltage levels, the amount of charge left, the amount of charge used, or the like of the aggregate and/or each individual battery. The display 16 may further include numeric readouts and/or analog dial or graph displays for each battery. From this screen, the user may be able to determine if any of the batteries are discharging more quickly than the others. In addition, the user may be able to select an indicator for an individual battery which displays another screen that includes detailed information on the battery such as its discharge history, as well as statistics, such as the average, on the voltage or charge level.

Furthermore, the user may be able to download, through the network port 20, all of the data that is recorded for all of the batteries. The data may include measured voltages and charges recorded at regular intervals. From this data, the user may be able to plot the history of the performance of the batteries, such as tracking the charging and discharging of the batteries over time, as well as statistics on each battery and the aggregate of the batteries.

In addition, the user may monitor parameters of the engine such as temperatures and pressures. One or more screens may show numeric readouts and/or analog dial or graph displays for each parameter as well as alerts when necessary. If desired, the user may view a history of any of the parameters or download recorded parameter data to an external device.

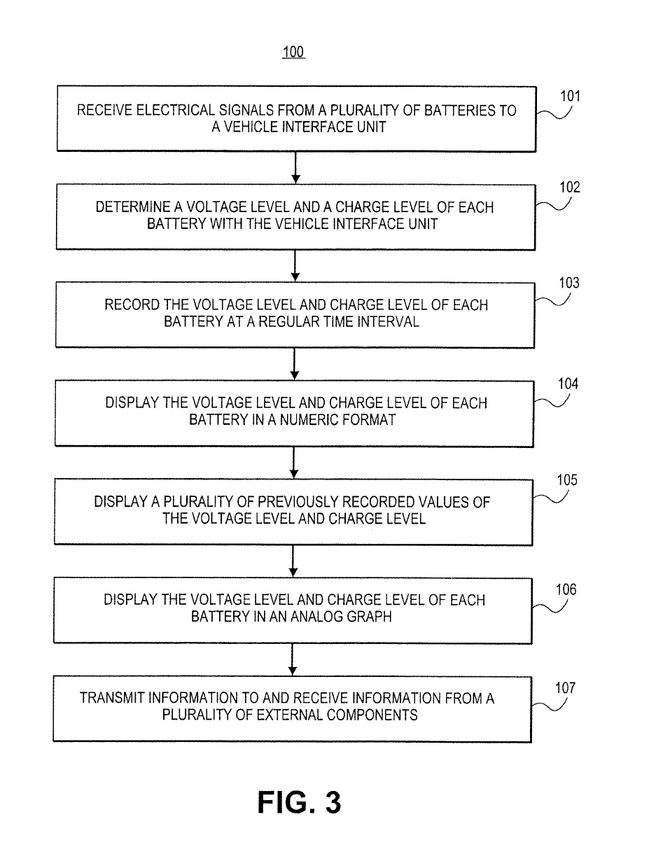

Steps of a method 100 for interfacing with an electric vehicle in accordance with various embodiments of the present invention are illustrated in FIG. 3. The steps may be performed in the order shown in FIG. 3, or they may be performed in a different order. Furthermore, some steps may be performed concurrently as opposed to sequentially. In addition, some steps may be optional.

Referring to step 101, a vehicle interface unit 24 receives electrical signals from a plurality of batteries. The batteries may be coupled to the vehicle interface unit 24 either by wire or wirelessly. The vehicle interface unit 24 may be in communication with a processing element 12.

Referring to step 102, a voltage level and a charge level of each battery is determined with the vehicle interface unit. The vehicle interface unit 24 may include circuitry such as ADCs, DACs, voltage and current level shifters, and the like which are operable to detect voltage and charge, and to which the batteries are coupled.

Referring to step 103, the voltage level and charge level of each battery are recorded at a regular time interval. The vehicle interface unit 24 may communicate with a memory element 14 through the processing element 12. The voltage level and charge level may be stored in the memory element 14.

Referring to step 104, the voltage level and charge level of each battery are displayed in a numeric format. The processing element 12 may be coupled to a display 16 on which the voltage levels and the charge levels are shown. For each battery, the display 16 may show a number representing the voltage level and a number representing the charge level of each battery.

Referring to step 105, a plurality of previously recorded values of the voltage level and the charge level is displayed. The previously recorded values may be retrieved from the memory element 14, and may be displayed for the aggregate or for each battery.

Referring to step 106, the voltage level and charge level of each battery are displayed in an analog graph. For each battery, the display 16 may show a graph representing the voltage level and a graph representing the charge level of each battery. Each graph may include either the voltage level or the charge level along the Y-axis and the number or name of the battery along the X-axis. The graph may include either a line or a shaded area indicating the appropriate level above the battery name or number. In other embodiments, the graph for each battery may include a portion of a circle or an arc representing a dial wherein the circumference of the circle indicates either the voltage level or the charge level and a line along the radius of the circle points to the appropriate level.

Referring to step 107, information is transmitted to and received from a plurality of external components. The external components may be coupled to a device port 22, that is in turn in communication with the processing element 12. The external components may broadly include a music player, such as an MP3 player, a video player, such as a Blu-Ray™ player, a navigation device, such as a GPS navigation device, and the like. The processing element 12 may receive information such as the status or settings of the external components and may transmit information commands or instructions to the external components. The processing element 12 send information regarding each component to the display 16.

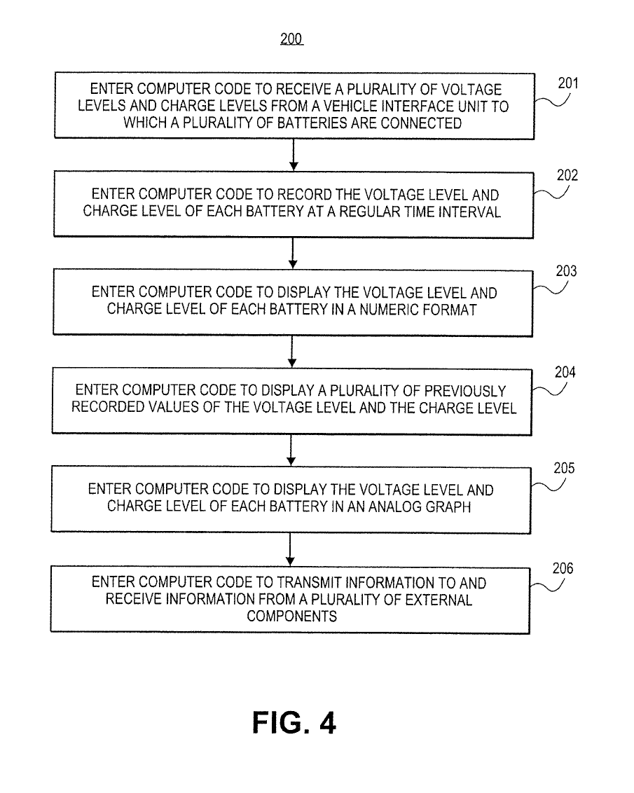

Steps of a method 200 for configuring a system 10 including a processing element 12 coupled with a memory element 14 that interfaces with an electric vehicle in accordance with various embodiments of the present invention are illustrated in FIG. 4. The steps may be performed in the order shown in FIG. 4, or they may be performed in a different order. Furthermore, some steps may be performed concurrently as opposed to sequentially. In addition, some steps may be optional.

Referring to step 201, computer code is entered into the system 10 to receive a voltage level and a charge level from a vehicle interface unit 24 to which a plurality of batteries are connected. The batteries may be coupled to the vehicle interface unit 24 either by wire or wirelessly. The vehicle interface unit 24 may be in communication with the processing element 12 and may include circuitry such as ADCs, DACs, voltage and current level shifters, and the like which are operable to detect voltage and charge.

Referring to step 202, computer code is entered into the system to record the voltage level and charge level of each battery at a regular time interval. The vehicle interface unit 24 may communicate with the memory element 14 through the processing element 12. The voltage level and charge level may be stored in the memory element 14.

Referring to step 203, computer code is entered into the system to display the voltage level and charge level of each battery in a numeric format. The processing element 12 may be coupled to a display 16 on which the voltage levels and the charge levels are shown. For each battery, the display 16 may show a number representing the voltage level and a number representing the charge level of each battery.

Referring to step 204, computer code is entered into the system to display a plurality of previously recorded values of the voltage level and the charge level. The previously recorded values may be retrieved from the memory element 14, and may be displayed for the aggregate or for each battery.

Referring to step 205, computer code is entered into the system to display the voltage level and charge level of each battery in an analog graph. For each battery, the display 16 may show a graph representing the voltage level and a graph representing the charge level of each battery. Each graph may include either the voltage level or the charge level along the Y-axis and the number or name of the battery along the X-axis. The graph may include either a line or a shaded area indicating the appropriate level above the battery name or number. In other embodiments, the graph for each battery may include a portion of a circle or an arc representing a dial wherein the circumference of the circle indicates either the voltage level or the charge level and a line along the radius of the circle points to the appropriate level.

Referring to step 206, computer code is entered into the system to transmit information to and receive information from a plurality of external components. The external components may be coupled to a device port 22, that is in turn in communication with the processing element 12. The external components may broadly include a music player, such as an MP3 player, a video player, such as a Blu-Ray™ player, a navigation device, such as a GPS navigation device, and the like. The processing element 12 may receive information such as the status or settings of the external components and may transmit information commands or instructions to the external components. The user may also be able to determine what information about each component, such as song titles, video titles, or navigation heading, is displayed. Furthermore, the user may be able to determine the appearance of the information, such as colors, fonts, position on the display 16, and the like.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A system for interfacing with an electric vehicle, the system comprising:
a display;
a vehicle interface unit operable to connect to a plurality of batteries and configured to determine a voltage level and a charge level of each battery; and
a processing element in communication with a memory element, the processing element programmed to record, store, and transmit the voltage level and the charge level,
wherein the processing element records the voltage level and the charge level of each battery at a regular time interval,
wherein the processing element stores the voltage level and the charge level of each battery in the memory element, and
wherein the processing element sends the voltage level and the charge level to the display to be displayed in a numeric format.

2. The system of claim 1, wherein the processing element is further programmed to send a plurality of previously recorded values of the voltage level and the charge level to the display.

3. The system of claim 1, wherein the processing element is further programmed to send the voltage level and the charge level to the display to be displayed in an analog graph format including the voltage level or the charge level along the Y-axis and the number of the battery along the X-axis.

4. The system of claim 1, wherein the numeric format includes a number that represents the voltage level and a number that represents the charge level for each battery.

5. The system of claim 1, wherein the processing element is further programmed to transmit information to and receive information from a plurality of external components selected from the group consisting of a music player, a video player, and a navigation device.

6. The system of claim 5, wherein the processing element is further programmed to send information regarding each external component to the display.

7. A non-transitory computer-readable storage medium with an executable program stored thereon for interfacing with an electric vehicle, wherein the program instructs a processing element to perform the following steps:
receiving a voltage level and a charge level from a vehicle interface unit to which a plurality of batteries are connected;
recording the voltage level and the charge level of each battery at a regular time interval; and
displaying the voltage level and the charge level of each battery in a numeric format.

8. The computer-readable storage medium of claim 7, wherein the program further instructs the processing element to a display plurality of previously recorded values of the voltage level and the charge level.

9. The computer-readable storage medium of claim 7, wherein the program further instructs the processing element to display the voltage level and the charge level of each battery in an analog graph format including the voltage level or the charge level along the Y-axis and the number of the battery along the X-axis.

10. The computer-readable storage medium of claim 7, wherein the numeric format includes a number that represents the voltage level and a number that represents the charge level for each battery.

11. The computer-readable storage medium of claim 7, wherein the program further instructs the processing element to transmit information to and receive information from a plurality of external components selected from the group consisting of a music player, a video player, and a navigation device.

12. The computer-readable storage medium of claim 11, wherein the program further instructs the processing element to display information regarding each external component.

13. A system for interfacing with a high-performance vehicle, the system comprising:
a display;
a vehicle interface unit operable to connect to components of an internal combustion engine and configured to determine a plurality of performance parameters; and
a processing element in communication with a memory element, the processing element programmed to record, store, and transmit the performance parameters and to transmit alerts,
wherein the processing element records each performance parameter at a regular time interval,
wherein the processing element stores each performance parameter in the memory element, and
wherein the processing element sends each performance parameter to the display to be displayed along with the alert for each performance parameter to indicate when the performance parameter exceeds a minimum or maximum boundary.

14. The system of claim 13, wherein the performance parameters include engine horsepower, engine torque, and vehicle acceleration.

15. The system of claim 13, wherein the performance parameters include fuel level, fuel pressure, fuel consumption, and fuel mixture.

16. The system of claim 13, wherein the performance parameters include engine exhaust temperature, engine air intake, and turbocharger pressure.

17. A non-transitory computer-readable storage medium with an executable program stored thereon for interfacing with a high-performance vehicle, wherein the program instructs a processing element to perform the following steps:
receiving a plurality of performance parameters from a vehicle interface unit to which components of an internal combustion engine are connected;
recording a value of each performance parameter at a regular time interval; and
displaying the value of each performance parameter and an alert for each performance parameter to indicate when the performance parameter exceeds a minimum or maximum boundary.

18. The computer-readable storage medium of claim 17, wherein the performance parameters include engine horsepower, engine torque, and vehicle acceleration.

19. The computer-readable storage medium of claim 17, wherein the performance parameters include fuel level, fuel pressure, fuel consumption, and fuel mixture.

20. The computer-readable storage medium of claim 17, wherein the performance parameters include engine exhaust temperature, engine air intake, and turbocharger pressure.

21. A method of configuring a system including a processing element coupled with a memory element that interfaces with an electric vehicle, the method comprising the steps of:
a) entering computer code into the system to receive a plurality of voltage levels and charge levels from a vehicle interface unit to which a plurality of batteries are connected;
b) entering computer code into the system to record the voltage level and charge level of each battery at a regular time interval; and
c) entering computer code into the system to display the voltage level and charge level of each battery in a numeric format.

22. The method of claim 21, further including the step of entering computer code into the system to display a plurality of previously recorded values of the voltage level and the charge level.

23. The method of claim 21, further including the step of entering computer code into the system to display the voltage level and charge level of each battery in an analog graph including the voltage level or the charge level along the Y-axis and the number of the battery along the X-axis.

24. The method of claim 21, wherein the numeric format includes a number that represents the voltage level and a number that represents the charge level for each battery.

25. The method of claim 21, further including the step of entering computer code into the system to transmit information to and receive information from a plurality of external components selected from the group consisting of a music player, a video player, and a navigation device.

26. The method of claim 25, further including the step of entering computer code into the system to determine what information regarding each component is to be displayed.

27. The method of claim 25, further including the step of entering computer code into the system to determine the appearance of the information regarding each component to be displayed.
